(19) United States
(12) Patent Application Publication
(10) Pub. No.: US 2015/0350636 A1
(43) Pub. Date: Dec. 3, 2015

(54) INFORMATION PROCESSING METHOD AND ELECTRONIC APPARATUS

(71) Applicant: LENOVO (BEIJING) CO., LTD., Beijing (CN)

(72) Inventor: Yi CHEN, Beijing (CN)

(73) Assignee: LENOVO (BEIJING) cO., ltD., Beijing (CN)

(21) Appl. No.: 14/389,712

(22) PCT Filed: Feb. 21, 2014
(86) PCT No.: PCT/CN2014/072377

§ 371 Date: Sep. 30, 2014

(30) Foreign Application Priority Data
Feb. 25, 2013 (CN) 201310058731.7

(51) Int. Cl. H04N 13/04

(52) U.S. Cl. CPC H04N 13/0475; H04N 13/0454

(57) ABSTRACT

The electronic apparatus of the present embodiment displays, by means of first display parameters, a first image, and, by means of second display parameters, a second image, thus allowing a user of said electronic apparatus to perceive a first display image at a first distance which is smaller than a second distance between the user and a display unit, and to perceive a second display image at a third distance which is greater than the second distance between the user and the display unit, thus resolving the technical problem in the prior art whereby a user wishing to view an image in 3D must be at a relatively precise position relative to the 3D display device in order to be able to view an image with 3D effects, failing which such effects are poor.

### CROSS REFERENCE TO RELATED APPLICATIONS

This application is a national phase application based on international application number PCT/CN2014/072377, filed on Feb. 21, 2014, which claims priority of Chinese Patent Application No. 201310058731.7, filed on Feb. 25, 2013, the contents of both of which are incorporated by reference herein in their entireties.

### BACKGROUND

The present disclosure relates to the field of electronic technology and particularly to an information processing method and an electronic apparatus.

With progressive development of science and technology, electronic technology has developed quickly. Various kinds of electronic products are more assessable; people enjoy the convenience brought by the development of the science and technology with the use of various kinds of electronic apparatus.

For example, a conventional 3D imaging device can output two different images, which are displayed simultaneously on a displaying unit of the 3D imaging device, so that a user can watch a 3D image constituent of the two images in a certain distance. The 3D image may be displayed protruding from the displaying unit to bring a 3D watching experience to the user.

However, it was found that that there are still the following conventional problems and defects relating to the procedure of implementing the present disclosure:

The conventional 3D imaging device makes the user able to watch an image with a 3D effect by displaying two images with a certain degree of separation simultaneously on the displaying unit. However, the user needs to be at a relatively accurate position with respect to the 3D imaging device to watch the image with the 3D effect at the current time. Thus, a technical problem results; there is a relatively poor imaging effect of the 3D imaging device and a single imaging mode.

### SUMMARY

The embodiments of this disclosure provide an information processing method and an electronic apparatus for solving the technical problems in which the user needs to be at a relatively accurate position with respect to the 3D imaging device to watch the image with the 3D effect when he wants to watch the image with the 3D effect resulting in the relatively poor imaging effect of the 3D imaging device. The specific technical solutions thereof are as follows:

An information processing method applied in an electronic apparatus including a display unit, the method comprising acquiring a first target object; displaying a first display image of the first target object on the displaying unit with a first display parameter, and displaying a second display image with a second display parameter, at the time of displaying the first display image with the first display parameter and displaying the second display image with the second display parameter, which is different from the first display parameter, a user of the electronic apparatus perceives that a first distance between the user and the first display image is shorter than a second distance between the user and the displaying unit and the user perceives that a third distance between the user and the second display image is longer than the second distance between the user and the displaying unit.

Optionally, displaying the first display image of the first target object on the displaying unit with the first display parameter and displaying the second display image with the second display parameter specifically comprising analyzing the first target object to acquire the first display image having the first display parameter and the second display image having the second display parameter; displaying the first display image of the first target object on the displaying unit with the first display parameter and displaying the second display image of the first target object with the second display parameter.

Optionally, displaying the first display image of the first target object on the displaying unit with the first display parameter and displaying the second display image with the second display parameter specifically comprising displaying the first display image of the first target object on the displaying unit with the first display parameter and displaying the second display image with a third display parameter at a first moment, at the time of displaying the first display image with the first display parameter and displaying the second display image with the third display parameter, the user of the electronic apparatus is able to perceive that the first distance is between the first display image and the user and the second distance is between the first display image and the second display image, and the second distance is a distance between the first display image and the displaying unit perceived by the user; displaying the first display image of the first target object with the first display parameter and displaying the second display image with the second display parameter at a second moment after the first moment, wherein, at the time of displaying the first display image with the first display parameter and displaying the second display image with the second display parameter which is different from the first display parameter, the user of the electronic apparatus perceives that the third distance between the user and the second display image is longer than the second distance.

Optionally, before displaying the first display image of the first target object on the display unit with the first display parameter and displaying the second display image of the first target object with the third display parameter at the first moment. The method comprises analyzing the first target object to acquire the first display image in the first target object; determining the first display object as being displayed with the first display parameter, and getting the second display image having the second display parameter from the electronic apparatus.

Optionally, said displaying the first display image of the first target object with the first display parameter and displaying the second display image with the second display parameter at the second moment after the first moment specifically comprising determining N temporary display parameters between the third display parameter and the second display parameter; determining N temporary display parameters between the third display parameter and the first display parameter; adjusting the second display image from the third display parameter to the second display parameter stepwise and adjusting the second display image from the third display parameter to the first display parameter stepwise according to the N temporary display parameters.

Optionally, before displaying the first display image of the first target object on the displaying unit with the first display parameter and displaying the second display image with the second display parameter. The method further includes detecting whether there is a first operation for adjusting a display mode of the first target object to generate a first detection result; generating a first adjusting instruction for controlling the electronic apparatus to display the first display image with the first display parameter and to display the second display image with the second display parameter when the first detection result represents that there is the first operation.

Optionally, there are a first operating mode and a second operating mode in the electronic apparatus, in response to it, before displaying the first display image with the first display parameter and displaying the second display image with the second display parameter. The method further includes detecting whether there is first information for switching the electronic apparatus from the first operating mode to the second operating mode; switching the electronic apparatus from the first operating mode to the second operating mode if there is the first information, the electronic apparatus displays the second display image with the third display parameter in the first operating mode and the electronic apparatus displays the first display image of the first target object with the first display parameter and displays the second display image with the second display parameter in the second operating mode.

An electronic apparatus comprising an acquiring unit for acquiring a first target object; a processing unit for displaying a first display image of the first target object on a displaying unit with a first display parameter and displaying a second display image with a second display parameter, at the time of displaying the first display image with the first display parameter and displaying the second display image with the second display parameter which is different from the first display parameter, a user of the electronic apparatus perceives that a first distance between the first display image and the user is shorter than a second distance between the user and the display unit, and the user perceives that a third distance between the user and the second display image is longer than the second distance between the user and the display unit.

Optionally, the processing unit includes an analyzing module for analyzing the first target object to acquire the first display image having the first display parameter and the second display image having the second display parameter in the first target object; a display module for displaying the first display image of the first target object on the display unit with the first display parameter and displaying the second display image of the first target object with the second display parameter.

Optionally, the processing unit further comprises a first processing module for displaying the first display image of the first target object on the displaying unit with the first display parameter and displaying the second display image with a third display parameter at a first moment, at the time of displaying the first display image with the first display parameter and displaying the second display image with the third display parameter, the user of the electronic apparatus is able to perceive that the first distance is between the first display image and the user and the second distance is between the first display image and the second display image, and the second distance is a distance between the first display image and the displaying unit perceived by the user; a second processing module for displaying the first display image of the first target object with the first display parameter and displaying the second display image with the second display parameter at a second moment after the first moment, wherein, at the time of displaying the first display image with the first display parameter and displaying the second display image with the second display parameter which is different from the first display parameter, the user of the electronic apparatus perceives that the third distance between the user and the second display image is longer than the second distance.

Optionally, the electronic apparatus further includes a detecting unit for detecting whether there is a first operation for adjusting a display mode of the first target object to generate a first detection result; an instruction generating unit for generating a first adjusting instruction for controlling the electronic apparatus to display the first display image with the first display parameter and to display the second display image with the second display parameter when the first detection result represents that there is the first operation.

One or more embodiments provided by the embodiments of this disclosure at least have the following technical effects or advantages:

By displaying the first display image with the first display parameter and displaying the second display image with the second display parameter by the electronic apparatus so as to make the user of the electronic apparatus to perceive that the first distance between the user and the first display image is shorter than the second distance between the user and the display unit and make the user to perceive that the third distance between the user and the second display image is longer than the second distance between the user and the display unit in the above-described embodiments, it solves the conventional technical problem that the user needs to be at a relatively accurate position with respect to the 3D imaging device to watch the image with the 3D effect when the user wants to watch the image with the 3D effect which results in relatively poor imaging effect of the 3D imaging device, and makes a position range of 3D imaging of the 3D imaging device longer and makes the user to be able to watch the 3D image with a more prominent effect, which improves the watching experience of the user greatly.

The embodiments of this application provide many kinds of operating modes of the electronic apparatus, and the electronic apparatus displays the first target object with different display parameters in different operating modes to make the electronic apparatus to select different display effects according to different display interfaces, which increase modes of effects of the electronic apparatus and improves the display effect of the electronic apparatus and also improves the degree of experience of the user.

### BRIEF DESCRIPTION OF THE DRAWINGS

FIG. 1 is a flow chart illustrating the information processing method in the embodiments of this disclosure.

FIG. 2 is a schematic diagram illustrating the watching effect of the user in the embodiments of this disclosure.

FIG. 3 is a schematic diagram of specific structure of the electronic apparatus in the embodiments of this disclosure.

### DETAILED DESCRIPTION

The embodiments of this disclosure provide an information processing method and an electronic apparatus, the information processing method includes acquiring a first target object; and then displaying a first display image of the first target object on a displaying unit of the electronic apparatus with a first display parameter and displaying a second display image with a second display parameter, at the time of displaying the first display image with the first display parameter and displaying the second display image with the second display parameter which is different from the first display parameter, a user of the electronic apparatus perceives that a first distance between the first display image and the user is shorter than a second distance between the user and the display unit, and the user perceives that a third distance between the user and the second display image is longer than the second distance between the user and the display unit.

Simply, in the embodiments, when the electronic apparatus acquires the first target object and needs to execute a processing of a 3D imaging effect to the first target object, the electronic apparatus determines the first display image required to be displayed using the first display parameter and the second display image required to be displayed using the second display parameter in the first target object, and displays the first display image according to the first display parameter and displays the second display image with the second display parameter at last, wherein, at the time of displaying the first display image with the first display parameter, the user is able to perceive that the first display image forms a display effect of protruding from the display unit, and at the time of displaying the second display image with the second display parameter, the user is able to perceive that the second display image forms a display effect of depressing in the display unit, so as to solve the conventional technical problem that the user needs to be at a relatively accurate position with respect to the 3D imaging device to watch the image with the 3D effect when the user wants to watch the image with the 3D effect which results in the relatively poor imaging effect of the 3D imaging device.

Hereinafter, the technical solutions of this disclosure are described detailed through the accompanying drawings and the specific embodiments, it should understand that the embodiments and the specific technical features in the embodiments are only detailed explanation of the technical solutions of this disclosure, but not restriction to the technical solutions of this disclosure, and the embodiments and the specific technical features in the embodiments can be combined with each other without conflict.

As shown in FIG. 1, FIG. 1 is a flow chart of the information processing method in the embodiments, the method includes:

Step 101, acquiring a first target object.

Step 102, displaying a first display image of the first target object on a displaying unit with a first display parameter and displaying a second display image with a second display parameter.

Firstly, in the embodiments, the electronic apparatus needs to acquire the first target object to be displayed and then analyzes the first target object, and the electronic apparatus analyzes the first target object to acquire the first display image having the first display parameter and the second display image having the second display parameter.

After analyzing the first display image and the second display image, the electronic apparatus displays the first display image on the display unit by using the first display parameter and displays the second display image on the display unit with the second display parameter at the same time.

In particular, the conventional 3D imaging device (an apparatus such as a 3D television or a computer having 3D display function or the like) makes the user to be able to watch the 3D image effect that the 3D imaging device is able to present in a certain distance by displaying two images having a certain degree of separation simultaneously. However, since the 3D imaging device can only protrude image to be presented according to a display parameter, which results in that the user can watch the image with the 3D effect only at a very accurate position, thus the conventional 3D imaging device has the technical problem of the poor 3D imaging effect.

In order to solve the above-described technical problem, in the embodiments, after the 3D imaging device acquires the first target object, i.e., acquires the image data to be displayed, the 3D imaging device analyzes the image data and then acquires the first display image and the second display image in the image data, and then the 3D imaging device decides whether there is the first display parameter in the first display image and decides whether there is the second display parameter in the second display image at the same time, wherein, the first display parameter is able to make the first display image to present a display effect of protruding from the display unit, and the second display parameter is able to make the second display image to present a display effect of depressing in the display unit. Of course, the display effect of protruding and depressing are effects perceived by the user but not effects of the 3D apparatus.

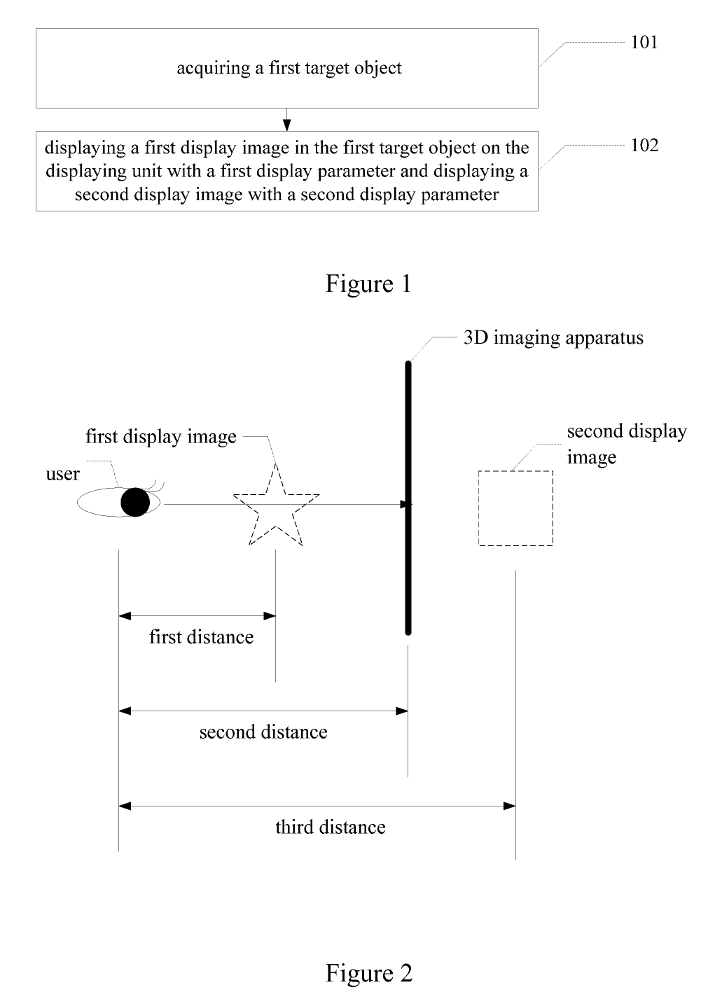

With the above-described decision, if the decision result represents that there is the first display image having the first display parameter and there is the second display image having the second display parameter in the image data, then the 3D imaging device displays the first display image on the display unit with the first display parameter and displays the second display image on the display unit with the second display parameter at the same time. Thus, the user may be made to perceive that the first distance between the first display image and the user is shorter than the second distance between the user and the display unit, and the user is also able to perceive that the third distance between the user and the second display image is longer than the second distance between the user and the display unit (as shown in FIG. 2).

It can be seen from FIG. 2 that, at the time of displaying the first display image with the first display parameter, the user is able to watch the first display image between eyeballs of the user and the 3D imaging device, that is, the display effect of the first display image protruding from the display unit, and the user is also able to watch that a distance between the second display image and the eyeballs of the user is longer than the distance between the eyeballs of the user and the 3D imaging device, that is, the second display image depressing in the display unit, such display modes of the image data may make the user to watch the 3D image effect in a wider range of view, which improves experience of 3D watching of the user.

In a procedure in which the electronic apparatus displays the first display image with the first display parameter and displays the second display image with the second display parameter in the embodiments, firstly, the electronic apparatus determines N temporary display parameters between the first display parameter and a third display parameter preset in the electronic apparatus, and the electronic apparatus also determines N temporary display parameters between the second display parameter and the third display parameter at the same time, the N temporary display parameters are for displaying the first display image and the second display image stepwise, so that the electronic apparatus adjusts the first display image from the preset third display parameter to the first display parameter stepwise and adjusts the second display image from the preset third display parameter to the second display parameter stepwise after determining the N temporary display parameters.

For example, in the 3D imaging device, when the 3D imaging device determines that it need to display the first display image with the first display parameter and display the second display image with the second display parameter at the same time, the 3D imaging device determines the N temporary display parameters between the first display parameter and the third display parameter firstly, and then in the procedure of adjusting the first display image from the first display parameter to the third display parameter stepwise through the N temporary display parameter display parameters, the user is able to perceive that the first display image protrudes from the display unit of the 3D imaging device gradually at this time, so as to be able to bring an effect of watching the 3D video gradually to the user.

In order for the display effect of the 3D imaging device being more smooth, in the embodiments, in addition to determining the N temporary display parameters between the first display parameter and the third display parameter, the 3D imaging device also determines the N temporary display parameters between the second display parameter and the third display parameter at the same time, and then the 3D imaging device adjusts the second display image from the third display parameter to the second display parameter stepwise through the N temporary display parameters. In particular, at the time of adjusting the second display image from the second display parameter to the third display parameter stepwise, the user would perceive that the second display image depresses in the display unit of the 3D imaging device gradually, to bring a better watching experience to the user.

It can be seen that from the above-described embodiment, in the embodiments, after determining the display parameter, the 3D imaging device adjusts the first display image and the second display image stepwise, and the first display image and the second display image are adjusted through the N temporary display parameters. Thus, the user is made to enter a 3D watching mode gradually, and the user is made to watch the 3D image in a wider range, to increase a usage experience of the user.

Also, the embodiments of this disclosure further includes another embodiment, in this embodiment, after the electronic apparatus acquires the first target object, the electronic apparatus analyzes to process the first display image from the first target object firstly, and then at the first moment, the first display parameter displays the first display image of the first target object on the display unit of the electronic apparatus with the first display parameter and displays the second display image with the third display parameter, wherein, at the time of displaying the first display image with the first display parameter and displaying the second display image with the third display parameter, the user of the electronic apparatus is able to perceive that there is the first distance between the first display image and the user and there is the second distance between the first display image and the second display image, and the second distance is a distance between the first display image and the display unit perceived by the user.

And then the first display image of the first target object is displayed with the first display parameter and the second display image is displayed with the second display parameter at the second moment after the first moment, wherein, at the time of displaying the first display image with the first display parameter and displaying the second display image with the second display parameter which is different from the first display parameter, the user of the electronic apparatus perceives that the third distance between the user and the second display image is longer than the second distance.

In particular, in this embodiment, the electronic apparatus acquires the first display image firstly, and then the electronic apparatus displays the first display image with the first display parameter at the first moment. It needs to explain that a procedure of adjustment of the first display image is also adjusting from the third display parameter to the first display parameter, and the third display parameter is a preset display parameter in the electronic apparatus. In addition, the electronic apparatus determines N temporary display parameters between the third display parameter and the first display parameter, and then adjust the first display image from the third display parameter to the first display parameter stepwise.

At the same time of adjusting the first display image from the third display parameter to the first display parameter stepwise, the electronic apparatus searches the second display image having the second display parameter in the electronic apparatus, and before adjusting the first display image, the electronic apparatus gets the second display image, and determines the N temporary display parameters between the third display parameter and the second display parameter at the same time, and adjusts the second display image from the third display parameter to the second display parameter stepwise while adjusting the first display image from the third display parameter to the first display parameter stepwise at last. In the end, the effect watched by the user is the first display image protruding from the display unit of the electronic apparatus gradually and the second display image depressing in the display unit in the electronic apparatus (as shown in FIG. 2).

Of course, in a procedure of displaying, there may be a case where there is an image overlapping between the first display image and the second display image. At this time, the electronic apparatus detects whether there is the image overlapping between the first display image and the second display image and generates corresponding detection result. when the detection result represents that there is the image overlapping between the first display image and the second display image, the electronic apparatus adjusts the first display image as a main display image, and adjusts the second display image as a sub display image, so that the second display image does not block the first display image when the user watches.

For example, in the 3D television, the first display image is the main display image and the second display image is a background display image, when the 3D television displays the main display image with a display parameter of positive depth of field, the 3D television would acquire the background display image having a display parameter of negative depth of field. The background display image may be a pre-stored background display image in the 3D television, and may be the background display image acquired by other manners. At this time, the 3D television would display the main display image with the display parameter of positive depth of field; of course, it is a procedure of adjusting stepwise. When the first display image is displayed with the display parameter of positive depth of field, the user may see the main display image being displayed protruding from the 3D television. At the same time, the 3D television would display the background display image with the display parameter of negative depth of field, and at this time, the background display image seen by the user would depress in the 3D television. Thus, the user is made to perceive that there forms a certain distance between the main display image and the background display image to make the main display image watched by the user to have a display effect of more obvious protrusion.

Then, the 3D television also detects whether there is an overlapping area between the main display image and the background display image in real time, and when there is the overlapping image between the main display image and the background display image, the 3D television determines the main display image and the background display image, and then covers the background display image by the main display image. Thus, the user does not feel an influence of image overlapping without influencing the display effect of the 3D television, which improves the watching effect of the user.

The 3D imaging device in the embodiments of the present invention not only adjusts the image of positive depth of field, and also displays the background image of negative depth of field on the 3D imaging device at the same time of displaying the image of positive depth of field, so as to make the position range of the 3D imaging of the 3D imaging device to increase, and make the user to be able to watch the 3D image with more protruding effect, which improves the watching degree of experience of the user greatly.

Further, in the embodiments of the present invention, the electronic apparatus also includes a first operating mode and a second operating mode, and the electronic apparatus detects whether there is first information for switching the electronic apparatus from the first operating mode to the second operating mode in real time, here, the first operating mode is a preset operating mode of the electronic apparatus.

The electronic apparatus is switched from the first operating mode to the second operating mode if there is the first information, wherein, the electronic apparatus displays the second display image with the third display parameter in the first operating mode and the electronic apparatus displays the first display image of the first target object with the first display parameter and displays the second display image with the second display parameter in the second operating mode.

Also by taking the 3D television as an example, in the embodiments, the 3D television includes a television mode (i.e., the first operating mode) and a movie watching mode or a menu mode (i.e., the second operating mode). when the user switches the 3D television from the usual television mode to the movie watching mode, the 3D television determines that output video data needs a 3D-enhanced effect, so that the 3D television analyzes the main display image and the background display image, and adjusts the main display image from an display effect of flat plane to a display effect of positive depth of field gradually, and then the 3D television adjusts the background display image from the display effect of flat plane to a display effect of negative depth of field gradually, so as to make the main display image watched by the user to have more prominent 3D imaging effect.

Of course, if the 3d television is switched from the television mode to the menu mode, the 3d television invokes a menu to be displayed firstly, and adjusts the menu from the display effect of flat plane to the display effect of positive depth of field, so that the user can watch the menu to be displayed protruding from the 3d television gradually. Of course, a procedure of popping the menu may be a procedure of adjusting from small to large gradually, which brings a more prominent 3D imaging effect to the user.

Further, in the embodiments, the adjustment of the display parameters of the first display image and the second display image are implemented in a function of enhancing the display effect, therefore, in the embodiments, the electronic apparatus detects whether there is a first operation for adjusting the display mode of the first target object to generate a first detection result, and generates a first adjusting instruction when the first detection result represents that there is the first operation. The first adjusting instruction is for controlling the electronic apparatus to display the first display image with the first display parameter and display the second display image with the second display parameter. Simply, whether the function of enhancing the display effect in the electronic apparatus is turned on is determined by detecting the operation of the user.

By displaying the first display image with the first display parameter and displaying the second display image with the second display parameter by the electronic apparatus so as to make the user of the electronic apparatus to perceive that the first distance between the user and the first display image is shorter than the second distance between the user and the display unit and make the user to perceive that the third distance between the user and the second display image is longer than the second distance between the user and the display unit in the above-described embodiments, it solves the conventional technical problem that the user needs to be at a relatively accurate position with respect to the 3D imaging device to watch the image with the 3D effect when the user wants to watch the image with the 3D effect which results in relatively poor imaging effect of the 3D imaging device, and makes the position range of the 3D imaging of the 3D imaging device longer and makes the user to be able to watch the 3D image with a more prominent effect, which improves the watching experience of the user greatly.

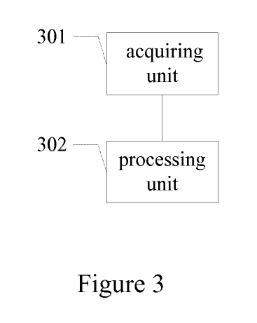

The embodiments of this disclosure further provide an electronic apparatus corresponding to the information processing method of the embodiments of this disclosure, as shown in FIG. 3. FIG. 3 is a schematic diagram of specific structure of the electronic apparatus of the embodiments of this disclosure, the electronic apparatus includes an acquiring unit 301 for acquiring a first target object; a processing unit 302 for displaying a first display image of the first target object on a displaying unit with a first display parameter and displaying a second display image with a second display parameter, at the time of displaying the first display image with the first display parameter and displaying the second display image with the second display parameter which is different from the first display parameter, a user of the electronic apparatus perceives that a first distance between the first display image and the user is shorter than a second distance between the user and the display unit, and the user perceives that a third distance between the user and the second display image is longer than the second distance between the user and the display unit.

Wherein, the processing unit 302 in the electronic apparatus includes an analyzing module for analyzing the first target object to acquire the first display image having the first display parameter and the second display image having the second display parameter in the first target object; a display module for displaying the first display image of the first target object on the display unit with the first display parameter and displaying the second display image of the first target object with the second display parameter.

Also, the processing unit 302 in the electronic apparatus may further includes a first processing module for displaying the first display image of the first target object on the displaying unit with the first display parameter and displaying the second display image with a third display parameter at a first moment, at the time of displaying the first display image with the first display parameter and displaying the second display image with the third display parameter, the user of the electronic apparatus is able to perceive that the first distance is between the first display image and the user and the second distance is between the first display image and the second display image, and the second distance is a distance between the first display image and the displaying unit perceived by the user;

A second processing module for displaying the first display image of the first target object with the first display parameter and displaying the second display image with the second display parameter at a second moment after the first moment, wherein, at the time of displaying the first display image with the first display parameter and displaying the second display image with the second display parameter which is different from the first display parameter, the user of the electronic apparatus perceives that the third distance between the user and the second display image is longer than the second distance.

Also, before the processing unit 302 displays the first display image of the first target object on the display unit with the first display parameter and displays the second display image with the second display parameter, the electronic apparatus further includes a detecting unit for detecting whether there is a first operation for adjusting a display mode of the first target object to generate a first detection result; an instruction generating unit for generating a first adjusting instruction for controlling the electronic apparatus to display the first display image with the first display parameter and to display the second display image with the second display parameter when the first detection result represents that there is the first operation.

One or more embodiments provided by the embodiments of this disclosure at least have the following technical effects or advantages:

By displaying the first display image with the first display parameter and displaying the second display image with the second display parameter by the electronic apparatus so as to make the user of the electronic apparatus to perceive that the first distance between the user and the first display image is shorter than the second distance between the user and the display unit and make the user to perceive that the third distance between the user and the second display image is longer than the second distance between the user and the display unit in the above-described embodiments, it solves the conventional technical problem that the user needs to be at the relatively accurate position with respect to the 3D imaging device to watch the image with the 3D effect when the user wants to watch the image with the 3D effect which results in relatively poor imaging effect of the 3D imaging device, and makes the position range of the 3D imaging of the 3D imaging device longer and makes the user to be able to watch the 3D image with a more prominent effect, which improves the watching experience of the user greatly.

The embodiments of this disclosure provide many kinds of operating modes of the electronic apparatus, and the electronic apparatus displays the first target object with different display parameters in different operating modes, so as to make the electronic apparatus to select different display effects according to different display interfaces, which increase modes of effects of the electronic apparatus and improves the display effect of the electronic apparatus and also improves the degree of experience of the user.

Those skilled in the art should understand that, the embodiments of this disclosure can be provided as method, system, or computer program product. Therefore, the present disclosure can adopt forms of full hardware embodiment, full software embodiment, or embodiment combining software and hardware aspects. And, the present disclosure can adopt form of one or more computer program products implemented on a computer usable storage medium (includes, but not limited to a magnetic disk storage, a CD-ROM, an optical memory or the like) including computer usable program code.

The present disclosure is described by referring to a flow chart and/or a block diagram of a method, an apparatus (a system) and a computer program product according to the embodiments of this disclosure. It should understand that each flow and/or block in the flow chart and/or block diagram and the combination of the flow and/or block in the flow chart and/or block diagram can be implemented by computer program instructions. These computer program instructions can be provided to processors of a general purpose computer, a dedicated computer, an embedded processor or other programmable data processing apparatus to generate a machine, so that a device for implementing functions specified in one or more flow of the flow chart and/or one or more block of the block diagram is generated by the instructions executed by the processor of the computer or other programmable data processing apparatus.

These computer program instructions can also be stored in a computer readable storage which is able to direct the computer or other programmable data processing apparatus to operate in specific manners, so that the instructions stored in the computer readable storage generate a manufactured article including a commander equipment, the commander equipment implements functions specified by one or more flow in the flow chart and/or one or more block in the block diagram.

These computer program instructions can be loaded to the computer or other programmable data processing apparatus, so that a series of operation steps are executed on the computer or other programmable data processing apparatus to generate a computer implemented process, so that the instructions executed on the computer or other programmable data processing apparatus provide steps for implementing functions specified in one or more flow of the flow chart and/or one or more block of the block diagram.

It is obvious that those skilled in the art can make various kinds of modifications and variations to this disclosure without departing from the spirit and scope of this disclosure. Thus, if these modifications and variations of this disclosure fall within the scope of the claims of this disclosure and the equivalent technology, this disclosure intends to incorporate these modifications and variations.

What is claimed is:

1. An information processing method applied in an electronic apparatus including a display unit, wherein the information processing method comprising:
acquiring a first target object; and
displaying a first display image of the first target object on the displaying unit with a first display parameter, and displaying a second display image with a second display parameter, at the time of displaying the first display image with the first display parameter and displaying the second display image with the second display parameter which is different from the first display parameter, a user of the electronic apparatus perceives that a first distance between the user and the first display image is shorter than a second distance between the user and the displaying unit, and the user perceives that a third distance between the user and the second display image is longer than the second distance between the user and the displaying unit.

2. The method according to claim 1, wherein said displaying the first display image of the first target object on the displaying unit with the first display parameter and displaying the second display image with the second display parameter comprises:
analyzing the first target object to acquire the first display image having the first display parameter and the second display image having the second display parameter; and
displaying the first display image of the first target object on the displaying unit with the first display parameter and displaying the second display image of the first target object with the second display parameter.

3. The method according to claim 1, wherein said displaying the first display image of the first target object on the displaying unit with the first display parameter and displaying the second display image with the second display parameter comprises:
displaying the first display image of the first target object on the displaying unit with the first display parameter and displaying the second display image with a third display parameter at a first moment, at the time of displaying the first display image with the first display parameter and displaying the second display image with the third display parameter, the user of the electronic apparatus is able to perceive that the first distance is between the first display image and the user and the second distance is between the first display image and the second display image, and the second distance is a distance between the first display image and the displaying unit perceived by the user; and
displaying the first display image of the first target object with the first display parameter and displaying the second display image with the second display parameter at a second moment after the first moment, at the time of displaying the first display image with the first display parameter and displaying the second display image with the second display parameter which is different from the first display parameter, the user of the electronic apparatus perceives that the third distance between the user and the second display image is longer than the second distance.

4. The method according to claim 3, wherein before displaying the first display image of the first target object on the displaying unit with the first display parameter and displaying the second display image of the first target object with the third display parameter at the first moment, the method comprises:
analyzing the first target object to acquire the first display image in the first target object; and
determining the first display object as being displayed with the first display parameter, and getting the second display image having the second display parameter from the electronic apparatus.

5. The method according to claim 3, wherein said displaying the first display image in the first target object with the first display parameter and displaying the second display image with the second display parameter at the second moment after the first moment comprises:
determining N temporary display parameters between the third display parameter and the second display parameter;
determining N temporary display parameters between the third display parameter and the first display parameter; and
adjusting the second display image from the third display parameter to the second display parameter stepwise and adjusting the second display image from the third display parameter to the first display parameter stepwise according to the N temporary display parameters.

6. The method according to claim 1, wherein before displaying the first display image in the first target object on the displaying unit with the first display parameter and displaying the second display image with the second display parameter, the method further comprising:
detecting whether there is a first operation for adjusting a display mode of the first target object to generate a first detection result; and
generating a first adjusting instruction for controlling the electronic apparatus to display the first display image with the first display parameter and to display the second display image with the second display parameter when the first detection result represents that there is the first operation.

7. The method according to claim 1, there are a first operating mode and a second operating mode in the electronic apparatus, in response to this, before displaying the first display image with the first display parameter and displaying the second display image with the second display parameter, the method further comprising:
detecting whether there is a first information for switching the electronic apparatus from the first operating mode to the second operating mode; and
switching the electronic apparatus from the first operating mode to the second operating mode if there is the first information, the electronic apparatus displays the second display image with the third display parameter in the first operating mode and the electronic apparatus displays the first display image in the first target object with the first display parameter and displays the second display image with the second display parameter in the second operating mode.

8. An electronic apparatus comprising:
an acquiring unit for acquiring a first target object; and
a processing unit for displaying a first display image of the first target object on a displaying unit with a first display parameter and displaying a second display image with a second display parameter, at the time of displaying the first display image with the first display parameter and displaying the second display image with the second display parameter which is different from the first display parameter, a user of the electronic apparatus perceives that a first distance between the first display image and the user is shorter than a second distance between the user and the display unit, and the user perceives that a third distance between the user and the second display image is longer than the second distance between the user and the display unit.

9. The electronic apparatus according to claim 8, wherein the processing unit comprises:
an analyzing module for analyzing the first target object to acquire the first display image having the first display parameter and the second display image having the second display parameter; and
a display module for displaying the first display image in the first target object on the display unit with the first display parameter and displaying the second display image in the first target object with the second display parameter.

10. The electronic apparatus according to claim 8, wherein the processing unit further comprising:
a first processing module for displaying the first display image in the first target object on the displaying unit with the first display parameter and displaying the second display image with a third display parameter at a first moment, at the time of displaying the first display image with the first display parameter and displaying the second display image with the third display parameter, the user of the electronic apparatus is able to perceive that the first distance is between the first display image and the user and the second distance is between the first display image and the second display image, and the second distance is a distance between the first display image and the displaying unit perceived by the user; and
a second processing module for displaying the first display image of the first target object with the first display parameter and displaying the second display image with the second display parameter at a second moment after the first moment, at the time of displaying the first display image with the first display parameter and displaying the second display image with the second display parameter which is different from the first display parameter, the user of the electronic apparatus perceives that the third distance between the user and the second display image is longer than the second distance.

11. The electronic apparatus according to claim 8, wherein the electronic apparatus further comprises:
a detecting unit for detecting whether there is a first operation for adjusting a display mode of the first target object to generate a first detection result; and
an instruction generating unit for generating a first adjusting instruction for controlling the electronic apparatus to display the first display image with the first display parameter and to display the second display image with the second display parameter when the first detection result represents that there is the first operation.
